(19) United States
(12) Patent Application Publication
(10) Pub. No.: US 2024/0370799 A1
(43) Pub. Date: Nov. 7, 2024

(54) System and Method for Enhancing Building Management Projects

(71) Applicant: Christopher Townsend Soles, Akron, OH (US)

(72) Inventor: Christopher Townsend Soles, Akron, OH (US)

(21) Appl. No.: 18/143,599

(22) Filed: May 4, 2023

(51) Int. Cl. G06Q 10/0631

(52) U.S. Cl. CPC G06Q 10/06313

(57) ABSTRACT

Herein systems and methods are disclosed for a novel method assisting users in selecting services relevant to their requirements and are presented with related costs, timelines and laws, and regulatory requirements in a completely automated manner. The system involves one or more processors, a back-end database, and a GUI-based interface allowing users to input the details relating to their requirements, retrieve the information from the database, and review and select the desired services. The process is completely automated with minimal user intervention, is transparent in nature and provides effective cost and timeline management tools.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCE TO RELATED APPLICATIONS

The present application includes subject matter disclosed in and claims priority to a provisional application entitled “System and Method for Enhancing Building Management Projects” filed May 3, 2023, and assigned Application No. 6346352 describing an invention made by the present inventor.

### BACKGROUND

### Field of the Invention

The present invention relates to computer-based systems used in the building construction industry. More particularly, the present invention relates to systems useful in the bidding, pricing, negotiating, selecting, scheduling, and management of building projects.

### Description of the Related Art

The construction of a building is undoubtedly a complex process requiring the coordination of individuals having skills in a broad range of disciplines such as general building, town planning, building codes, trades, and engineering. The process is beyond the capability of many owners or owner-builders desirous of instigating and managing a building construction project on their own. While such difficulties arise for projects directed to single dwellings, greater problems present for the owner or owner-builder involved in more complex projects such as multi-unit developments. For example, multi-unit developments typically involve the subdivision of land and more complex costing issues given that certain services may be shared between individual units.

A significant problem in building construction is in costing the entire process, or even a part of the process Given that most owners and owner-builders do not understand the mandatory requirements of building, any attempt at even rough pricing often fails given that some mandatory items may not be included.

While the owner or owner-builder may retain the services of a builder to prepare estimates, the estimates are often inaccurate and are typically inflated. Builders are prone to “round up” estimates on construction materials and trades services to ensure that are not financially disadvantaged. Furthermore, the estimate may be based on an inclusion list (i.e., a list of features covered in the estimate) that is vague, confusing, or otherwise ill defined.

Due to the inherent complexity of building contracts and the many hidden costs potentially chargeable by a builder, the owner is often faced with additional costs. Indeed, these additional costs are often a core part of a builder's income. The lack of accuracy and transparency in costing makes planning, arranging finance and even the decision whether or not to even commence building difficult. Accurate estimates are necessary so that a potential owner or owner-builder can gauge the commercial viability of a building project, arrange finance, and properly control the budget over the course of the project.

Containing budgets is further complicated given many options available when designing a building. While selecting various alternatives such as building materials, fittings, and floor coverings it is often the case that the options chosen lead to a final estimate that is greater than the allocated budget.

Another problem for the owner or owner-builder is scheduling. Accurate scheduling is necessary to ensure that costs can be met when they become payable, to ensure that materials and services are in place when required and that deadlines for filing official requirements can be met. Furthermore, the ability of an owner-builder to provide realistic timeframes for tasks undertaken by tradespersons results in decreased pressure to have those tasks completed, or “callbacks” from having sites not adequately prepared. Accurate scheduling also provides for a set completion date so that tenants may be pre-arranged resulting in the property generating income at the earliest opportunity.

Another problem faced by owners, owner-builders (and even smaller professional builders) are the difficulty in purchasing materials and labor at prices that are comparable to those achievable by larger builders. Material suppliers provide smaller customers with limited support in terms of company representatives and discounted pricing.

The total cost of a building construction project may be affected by global factors such as the price of copper, oil, concrete etc., and also local market factors such as labor rates which are generally driven by demand. As a result, the pricing fluctuations are regular, and it is difficult to maintain accurate cost estimates over the course of a building project.

A further problem relates to managing the progress of building projects to ensure that deadlines are met, and schedules are adhered to. Owners and owner-builders require a simple mechanism to monitor the progress of a construction project to check that milestones are being met.

By looking at prior art multiple advancements have been seen in similar regards. For instance, a U.S. Pat. No. 2,005,0197856A1 relates to system, method, and process for managing problems and risks associated with a construction project using project-specific software and project notice forms relative to the construction contract. The system and method are disclosed for providing instant access to notices for any notice-triggering event which may occur on a specific construction project. More specifically, the present invention is essentially a system and method for managing problems and risks associated with a wide range of construction projects using a project-specific software, system, method, and process, usually accompanied by “hard copy” printouts of the relevant notices, forms and letters and the specific contract provisions that require a specific notice to be given by the construction company. In one embodiment, a customized CD-ROM package of notice documents that fully comply with a particular contract is prepared, which software package is then utilized to bring up appropriate notice document on a computer screen, which notice document is then completed by a user by inserting relevant information in open fields of the draft notice document.

A U.S. Pat. No. 2,001,0027407A1 relates to control and inquiry system for construction work. The control and inquiry system handles construction project information that is related to the construction of a building. The construction project information includes content information, work schedule information, work progress information and change order information and is maintained on a control and inquiry computer system that is coupled to a computer network. Construction project information may be accessed by a home builder computer system and a client computer system that are also coupled to the computer network.

A U.S. Pat. No. 7,062,514B2 relates to construction project submittal management. The network-based construction project management system. The system includes network accessible databases of project information including drawings and specifications. The system allows for varying amounts of access for various users including general contractors, subcontractors, architects, and project owners. The system allows for the effective creation, management, and long-term accessible storage of project submittals.

A US patent 20070078771A1 relates to construction payment management system and method with document tracking features. The system and method of managing a construction payment process involving a plurality of participants associated with the construction project and at least one document to be transferred between at least two participants of the plurality participants during the course of the construction project. One method can include assigning at least one enforcement action to at least one document wherein the enforcement action is automatically affected if the document is not transferred between the at least two participants.

A U.S. Pat. No. 8,306,883B2 relates to construction payment management systems and methods with specified billing features. The system and methods for managing payments. One construction of the system includes a software enabled user interface accessible by a first party and a second party, at least one computer readable memory, and a processor. The processor is configured to selectively operate in a specified billing mode in response to an input received from the first party. The processor is configured to receive invoice details from the first party when operating in the specified billing mode and from the second party when not operating in the specified billing mode. The processor is further configured to generate an invoice based on the invoice details, display the invoice to the first party and the second party, and request an approval or a rejection of the invoice from the first party or the second party.

The prior art provides several software packages allowing builders and professional estimators to connect, cost a project, hire the team and get industry news; however, these packages presume a level of knowledge and are of little use to an individual not having a firm understanding of building construction. It is an aspect of the present invention to overcome a problem of the prior art and provide a computer-implemented method that is usable by an individual not having significant knowledge of the building industry and provides information in an automated and transparent manner.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

It is therefore the purpose of the invention to alleviate at least to some extent one or more of the aforementioned problems of the prior art and/or to provide the relevant public with a suitable alternative thereto having relative advantages.

The primary object of the invention is related to the provision of a model that entails operating a marketplace connecting customers with construction services providers, with a focus on architects and contractors.

It is also the objective of the system aimed at reducing the complexity of the design and construction process.

It is also the objective of the system to provide various inspections and guidance on comparable and ARV values, which can help investors and homebuyers make informed decisions about their investments and purchases, resulting in saving time, money and stress born during a traditional process.

It is the further objective of the system aimed at organizing and streamlining construction projects by empowering users to obtain designs, licenses, and construction services under one single roof. Users can go on the website, create a profile, and start shopping for architectural services.

It is further the objective of system to provide a comprehensive platform that offers a variety of services to assist real estate investors and homebuyers throughout the entire investment process, from breaking ground to selling or renting the property.

It is also the objective of the system to provide completely automated and transparent information to every party and thus building the trust of users in each other and the service provider platform.

It is also the objective of the system to provide an interface that is easy to use and a variety of information can be obtained by simple clicks.

It is also the objective of the system wherein all the process is automated thus it enhances the efficiency of output, provides better insight to the customers, and reduces the overall cost as compared to the manual process.

This Summary is provided merely for purposes of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

The accompanying drawings, which are incorporated herein and form a part of the specification, illustrate some, but not the only or exclusive, examples of embodiments and/or features.

FIG. 1 showing a representative view of the method.

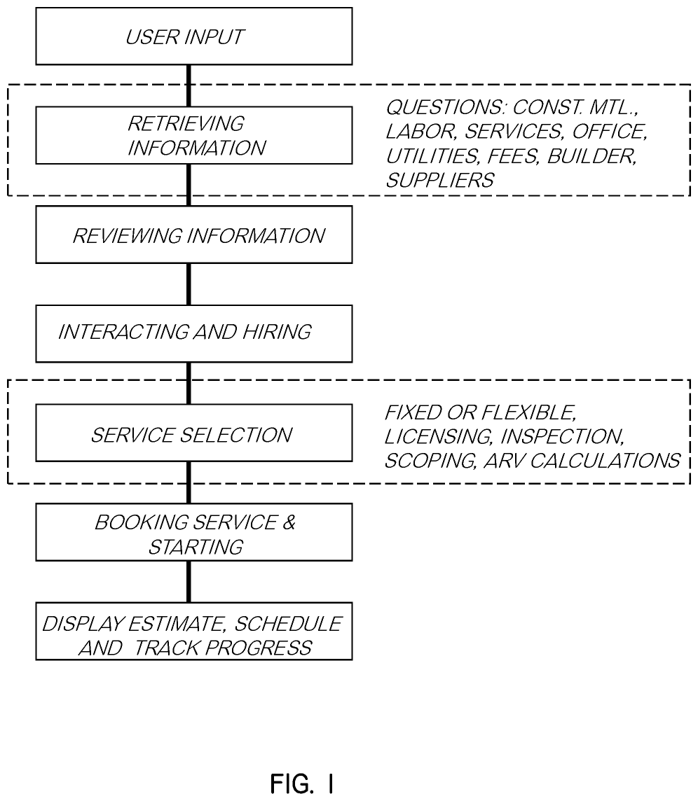

Other aspects of the present invention shall be more readily understood when considered in conjunction with the accompanying drawings, and the following detailed description, neither of which should be considered limiting.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner.

The current invention in its preferred embodiment discloses an efficient and completely automated system of construction projects. The present invention is predicated at least in part on Applicant's finding that individuals who would otherwise not have the ability to properly select the contractors, cost, schedule, monitor or generally manage building project/s are enabled to do so where they are provided with a computer-based method for managing the project that includes a database containing up-to-date data relating to the many fees, requirements, services, licensing, laws and the like necessary for the construction of a building.

The present invention facilitates individuals who would otherwise not have the ability to properly cost, schedule, monitor or generally manage a building project are enabled to do so where they are provided with the computer-based method for managing the project that includes a database containing up-to-date data relating to the many fees, requirements, services and the like necessary for the construction of a building. Accordingly, in the first aspect the present invention provides a computer-implemented method for assisting a user in costing and/or scheduling and/or managing a building construction project.

Relevant to accurate costing, Applicant has recognized that estimating programs of the prior art are deficient by basing estimates on materials and labor pricing entered by the user at the time of purchasing the software, or at the commencement of the project. Without substantially current data, cost estimates become unreliable. This issue arises also where the project includes a product which is superseded and/or updated during the building project. Each time a new version comes onto the market, a manual change is required to prior art estimating software.

In addition to the above, many existing software packages are designed for more sophisticated users (such as builders, trades persons, and building estimators) who already have a sound working knowledge of building construction. Such packages make many assumptions regarding the user's knowledge of building as so can be essentially unworkable in the hands of an owner or owner-builder builder. Furthermore, software packages of the prior art typically rely on information that is suitable only for specific jurisdictions, be it a council area, state, or country. By contrast, the present methods are customizable by virtue of the administrator-controlled database which may be configured to hold relevant information allowing a user to complete possibly an entire construction process in their location of choice.

In the first aspect, the present invention provides a computer-implemented method for assisting a user in selecting, costing and/or scheduling, and/or managing a construction project, where one or more processors are programmed to perform the steps comprising: (i) receiving a user input relating to details of the construction project, (ii) retrieving from a database, information relevant to contractors, estimated project cost and/or scheduling and/or management, the information retrieved from the database also being related to the user input, (iii) displaying list of selected contractors based on user's defined parameters, cost estimate and/or a project schedule and/or project progress. In one embodiment of the method, the user is an owner, an owner-builder, or a small commercial building entity.

The information contained in the database may be selected from one or more of: contractors' details, construction materials pricing, construction labor pricing, professional services pricing, trade services pricing, office services pricing, utility connection pricing, official fees, official requirements for construction, equipment hire, the identity of a builder, the identity of a construction material supplier, the identity of a construction labor supplier, the identity of a professional services supplier, the identity of a trade services supplier, the identity of an office services supplier, the identity of a utility connection supplier, either alone or in any combination.

In one embodiment of the method the user is guided through a series of questions and/or steps designed to provide pricing, scheduling or management information, the questions and/or steps being (in one embodiment) dependent on the user's answers to previous questions or on the previous steps through which the method has proceeded. In addition, or alternatively, the selections available at a certain question and/or step are dependent on the user's answers to previous questions or on the previous steps through which the method has proceeded. In addition, or alternatively, the selections available at a certain question and/or step are dependent on the user's selections in previous steps through which the method has proceeded. In addition, or alternatively, the questions and/or steps through which the user is guided are dependent on information in the database. In one embodiment of the method, the building construction project is a multi-unit development project. The method may comprise the automated generation of one or more documents involved in the building, the contents generated according to user input and database information.

In a second aspect, the present invention provides computer software capable of executing a computer-implemented method as described herein.

In a third aspect, the present invention provides a computer database containing information selected from one or more of construction materials pricing, construction labor pricing, professional services pricing, trade services pricing, office services pricing, utility connection pricing, official fees, official requirements for construction, the identity of a construction material supplier, the identity of a construction labor supplier, the identity of a professional services supplier, the identity of a trade services supplier, the identity of an office services supplier, the identity of a utility connection supplier, either alone or in any combination.

As used herein, the term “computer-implemented” is intended to mean that the method is operable at least in part or even entirely on any processor-equipped device such as a personal computer, laptop, netbook, tablet, PDA, smart phone, and other similar contrivances The method may be implemented on a single computer or across multiple computers connected to a LAN, WAN, or the Internet. The method may be implemented in the form of standalone software adapted to be installed on a single computer. In that scenario, the database is typically retained on a single computer with the database being updated via internet download or by any other method such as optical, magnetic, or flash storage media being connected to the computer.

Preferably the method is embodied without the need to install dedicated software or database information on the user's computer. For example, the entire method may be embodied in a server remote form the user's computer, with data transmission between the computer and server being via the Internet, by way of a browser platform such as Microsoft Internet Explorer™, Google Chrome™, Mozilla Firefox™ or Apple Safari™ . Indeed, an Internet-based implementation is preferred since the database information is kept current to date on a single server such that any modifications are immediately accessible to all users.

In the context of the present invention the term “building construction project” is intended to include any project directed the construction of a building, including a residential dwelling, a complex of residential dwellings, a commercial building such as a retail store, an office, or a warehouse. The term is not intended to be limited to a complete construction project (such as the construction of a dwelling from the foundations through to completion) but may refer to constructing a dwelling only to the “lock-up” stage. The term may also include a complete or partial renovation to an existing building.

The user input required by the present computer-implemented methods is typically prompted by a series of questions or options raised by the computer. In response, the appropriate input is provided by the user by selecting various menu items, and submenu items, navigating pre-populated drop-down menus, clicking actionable buttons, typing information into form fields and so on.

The database may be any type of database that is capable of being read from, and optionally written to. Typical options include the flat-file style of database useful for smaller amounts of data that need to be human readable or edited by hand. Preferably a Database Management layer is added to this type of database allowing script programmers to store information as a pair of strings whereby a key is used to find the associated value. More complex data structures will be better managed using relational databases such as MySQL Microsoft SQLServer and Oracle, given their more logical structure in the way data is stored. Tables can be used to represent real-world objects, with each field acting as an attribute. For example, a table called “floor tiles” could have columns “size”, “colour” and “finish”, which describe the details of each type of floor tile stored in a database of building materials. The step of “displaying” the cost estimate, project schedule or project progress may be achieved by presenting the user with any comprehensible information including by way of display on a computer monitor or by printed means.

As used herein the term “substantially current” means that the information is broadly applicable to a building construction project at the time of execution of the computer-implemented method by the user. For example, pricing information relating to hardware, labor, professional services et cetera must be reasonably current to allow for the generation of accurate cost estimates Similarly, the information in the database must reflect current building codes such that any cost estimate, schedule, or progress report is practically useful. It will be understood that the information is not necessarily required to be absolutely current, but preferred embodiments of the method provide for a database with information that is updated or potentially updated every 1 minute, 5 minutes, 10 minutes, 20 minutes, 30 minutes, 40 minutes, 50 minutes, 1 hour, 2 hours, 3 hours, 4 hours, 5 hours, 6 hours, 12 hours, 18 hours, 1 day, 2 days, 3 days, 4 days, 5 days, 6 days or 1 week.

The present method may be adapted to compensate for any alterations in the database that affect project costing, scheduling, or management by executing a validation step against current projects after a database modification is made. For example, if the user generates a cost estimate for the construction of a dwelling based on a database entry directed to a law requiring boundary fences between adjoining properties only, but local council requirements change such that a fence is also required to the front of the property, then after updating the database the validation process would detect an inconsistency between current fencing requirements and the length of fencing selected.

The user would then be prompted to increase fencing requirements when opening their project file. In one embodiment of the invention, the method provides output useful in the scheduling of a construction building project. Accurate scheduling is a difficult yet important task in construction given the need to temporally arrange many actions, services, payments, document submissions and the like for the project to run smoothly and economically. Building projects can typically be described by way of a series of tasks, with the completion of one task often being a prerequisite to the commencement of another of another task. As a simple example, the framing of a house cannot be commenced until the foundations are completed. Typically, the output is predominantly by graphical means, such Gantt chart or similar. Other forms of output are contemplated including graphical timelines, calendar-based systems, and simple text means.

In one embodiment of the invention, the method provides output useful in the management of a construction building project. Typically, the method will allow the user to enter the completion of various tasks in the project so that the output is representative of the state of affairs at any given time. A preferred method of output is the Gantt chart, and more preferably a dynamic Gantt chart. Progress within a given task of the chart may be shown within a bar of the Gantt chart.

The system also aims at providing an interface wherein each button on the web page of Timeline Dashboard LLC represents links to real and inspection services, as well as other necessary processes in the residential estate sector. These links can make it easier for users to navigate the platform and access the specific services they need.

The system also aims at saving users time and effort in finding the necessary resources to complete their real estate transactions. This can be especially helpful for those who may not have extensive experience in the real estate industry and are not familiar with all the processes involved.

The system also provides a variety of dashboards wherein the dashboard for contractors is named as Timeline Dashboard and is used to manage the various phases of a construction project, from planning and design to execution and completion. The tool can help contractors schedule tasks, track progress, and manage resources, such as labor, materials, and equipment. This can help ensure that projects are completed on time, within budget, and to the satisfaction of the homeowner or investor.

The system also includes a dashboard for homeowners and investors. The Timeline Dashboard can be used to track the progress of a construction project, monitor costs and budgets, and communicate with the contractor. The tool can provide real-time updates on the status of the project, as well as any changes or delays that may occur. This can help homeowners and investors stay informed and make informed decisions about the project.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A computer/application-implemented method for assisting a user in selecting services of contractors, costing and/or scheduling and/or managing a construction project, where one or more processors are programmed to perform the steps comprising:
(i) receiving user input relating to details of the construction project,
(ii) retrieving from a database, information relevant to project cost and/or scheduling and/or management, the information retrieved from the database also being related to the user input,
(iii) displaying a cost estimate and/or a project schedule and/or project progress, wherein the information contained in the database also shows the service providers and these service providers are displayed in proximity of user using GPRS functionality.

2. A computer/application-implemented method according to claim 1, wherein the user is an individual owner, an owner-builder, or a small commercial building entity.

3. A computer/application-implemented method according to claim 1, wherein the information contained in the database is selected from one or more of: construction materials pricing, construction labor pricing, professional services pricing, trade services pricing, office services pricing, utility connection pricing, official fees, official requirements for construction, equipment hire, the identity of a builder, the identity of a construction material supplier, the identity of a construction labour supplier, the identity of a professional services supplier, the identity of a trade services supplier, the identity of an office services supplier, the identity of a utility connection supplier, either alone or in any combination.

4. A computer/application-implemented method according to any one of claim 1, wherein the users can browse, interact, and hire local talent for a variety of exceptional range of designs and construction solutions.

5. A computer/application-implemented method according to any one of claim 1, wherein the method comprises the step of transmitting any or all input and/or output of the method to a reviewer or requesting or allowing a reviewer to access any or all input and/or output data for the purpose of review.

6. A computer/application-implemented method according to any one of claim 1, wherein the user is guided through a series of questions and/or steps designed to provide pricing, scheduling, or management information.

7. A computer/application-implemented method according to claim 1, wherein the questions and/or steps are dependent on the user's answers to previous questions or on the previous steps through which the method has proceeded.

8. A computer/application-implemented method according to claim 1, wherein the selections available at a certain question and/or step are dependent on the user's answers to previous questions or on the previous steps through which the method has proceeded.

9. A computer/application-implemented method according to claim 1, wherein the user can select the services required and can review all of the related costing and timeline information.

10. A computer/application-implemented method according to claim 1, wherein the user can book the services and can start the project.

11. A computer/application-implemented method according to claim 1, wherein the project can be a fixed-time project or flexible project in nature.

12. A computer/application-implemented method according to claim 1, wherein each and every step of the construction project is completely automated, and all of the relevant information is recorded and can be displayed through a variety of interfaces.

13. A computer/application-implemented method according to claim 1, wherein necessary licensing is involved in a construction project can also be applied through the system

14. A computer/application-implemented method according to claim 1, wherein a variety of dashboards is presented to Fusers as per their role.

15. A computer/application-implemented method according to claim 1, wherein the contractor's Dashboard is used to manage the various phases of a construction project, from planning and design to execution and completion and help contractors schedule tasks, track progress, and manage resources, such as labor, materials, and equipment.

16. A computer/application-implemented method according to claim 1, wherein homeowners' and investors' Timeline Dashboard can be used to track the progress of a construction project, monitor costs and budgets, and communicate with the contractor. The tool can provide real-time updates on the status of the project, as well as any changes or delays that may occur.

17. A computer/application-implemented method according to claim 1, wherein homeowners' and investors' Timeline Dashboards help homeowners and investors stay informed and make informed decisions about the project.

18. A computer/application-implemented method according to claim 1, wherein Time Travel Developments LLC in the platform is a style of futuristic designs of number 1 selling homes of times past and the future into designed Time Travel Developments LLC.

19. A computer/application-implemented method according to claim 1, wherein the platform is an Investor Inspector LLC to assist with the inspection, estimating, scope writing, ARV calculations and comparable.

20. A computer/application-implemented method according to claim 1, wherein the ARV values and comparable in real estate is also provided through the interface/application.

21. A computer/application-implemented method according to claim 1, wherein the platform is a Drain-A-Way LLC offering aerospace technology with design and waterproofing systems.

22. A computer/application-implemented method according to claim 1, wherein the platform is an Abatement Lead Clearance/Risk Assessment LLC offering services in government lead programs.

23. A computer/application-implemented method according to claim 1, wherein the platform uses a budgeting software program On Point Budgeting LLC offering financial oversight, budgeting, project management and collaboration features.

24. A computer/application-implemented method according to claim 1, wherein the platform offers financial lending in purpose to assist in real estate purchases.

25. A computer/application-implemented method according to claim 1, wherein the platform uses Face Lifter Flipper LLC to increase the façade of a property with innovative, futuristic design strategies.
